(19) United States
(12) Patent Application Publication
(10) Pub. No.: US 2025/0180786 A1
(43) Pub. Date: Jun. 5, 2025

(54) Optics for Regulated Vehicle Lighting Applications

(71) Applicant: MagWerks Vision Inc., Oxford, MI (US)

(72) Inventors: Michael F. Pickholz, Oxford, MI (US); Steven Francis Tregilgas, Oxford, MI (US)

(21) Appl. No.: 19/052,855

(22) Filed: Feb. 13, 2025

Related U.S. Application Data
(63) Continuation-in-part of application No. 18/357,645, filed on Jul. 24, 2023, now Pat. No. 12,248,156.
Application No. 18/357,645 is a continuation of application No. 17/365,064, filed on Jul. 1, 2021, now abandoned.

(51) Int. Cl. G02B 3/00; F21S 41/143; F21S 41/26; F21S 41/265; F21S 41/32; F21S 43/31; F21S 43/40; F21V 7/00

(52) U.S. Cl. CPC G02B 3/0031; F21S 41/143; F21S 41/26; F21S 41/32; F21S 41/322; F21S 43/315; F21V 7/0091; G02B 3/0056; F21S 41/265; F21S 43/402

(57) ABSTRACT

A lamp for a vehicle has a unitary molded body comprising a total internal reflection (TIR) optic having a front surface configured as a light exit and an integral attachment portion extending from at least a portion of a perimeter of the front surface. An opaque structure is positioned adjacent to and on an internal side of the integral attachment portion.

### CROSS-REFERENCE TO RELATED APPLICATION(S)

This application is a continuation-in-part of U.S. patent application Ser. No. 18/357,645, filed on Jul. 24, 2023, which is a continuation of U.S. patent application Ser. No. 17/365,064, filed on Jul. 1, 2021, the entire disclosures of which are hereby incorporated by reference.

### TECHNICAL FIELD

This disclosure relates to the field of optics used in lamps utilized for illumination or signalization in regulated applications, such as vehicle headlamps, tail lamps and signal lamps. The optics may be made from optical silicone to be used with LEDs. The optics are unitary structures incorporating the lens and total internal reflector (TIR) and are able to provide the requisite illumination with no additional lens or reflector.

### BACKGROUND

Optical lenses engineered to harness and direct sources of light are produced with basic techniques devised to tailor light output. Since the 1980's, plastic lenses have steadily replaced glass as the transparent outer enclosure for lighting applications in most fields and metal or plastic is used for the reflectors. Historically, plastic lenses have been produced from rigid materials, such as, but not limited to, polycarbonate (PC), poly (methyl methacrylate) (PMMA), polystyrene (PS), cyclic olefin polymer (COP), cyclic olefin copolymer (COCP).

These materials are essentially rigid in nature, not substantially deforming under applied pressure or through the force of gravity. Once properly fixed and in place, such materials essentially retain their geometric configuration. Furthermore, separate components (e.g., lens and reflector) can lead to additional disadvantages and low efficiency. There is an ever-growing need for weather-proof, light-weight lamps for electric and autonomous vehicles that can meet the different prescription requirements of the various applications while also meeting mandated specifications.

### SUMMARY

Disclosed herein are embodiments of unitary prescription optics. One example of a unitary prescription optic as disclosed herein has a molded silicone body comprising: a front surface configured as a light exit; an integral reflector configured to receive and reflect light from an LED light source; and an integral attachment portion configured to mount the molded silicone body within a housing.

Also disclosed herein are lamps, such as for vehicles. One example of a lamp has a unitary molded body molded from silicone comprising: a front surface configured as a light exit; an integral reflector molded to meet a prescription light output; and an integral attachment portion. The lamp also includes an LED light source, the integral reflector receiving and reflecting light from the LED light source, and a housing configured to mount the unitary molded body within a structure, the integral attachment portion attached directly to the housing without an additional seal member. Another example disclosed herein is a lamp for a vehicle having a unitary molded body comprising a total internal reflection (TIR) optic having a front surface configured as a light exit and an integral attachment portion extending from at least a portion of a perimeter of the front surface. An opaque structure is positioned adjacent to and on an internal side of the integral attachment portion.

In some examples herein, the unitary molded body consists of a TIR optic having a front surface and an integral attachment portion extending from the entire perimeter of the front surface.

Another example disclosed herein is a lamp having a unitary molded body forming a TIR optic with a front surface configured as a light exit and an attachment portion extending from a perimeter of the front surface. An opaque structure is configured as a light barrier to prevent light from exiting through a surface other than the front surface. A substrate carries a light source, the substrate in contact with one or both of the attachment portion and the opaque structure to enclose the lamp.

Another example disclosed herein is a lamp for a vehicle having a unitary molded body comprising an optic having a front surface configured as a light exit and an integral attachment portion extending from a perimeter of the front surface. An opaque structure is internal to the integral attachment portion. The integral attachment portion extends from the perimeter of the front surface in a rearward direction substantially perpendicular to the front surface.

Also disclosed is a vehicle comprising an exterior component having an aperture and a lamp as disclosed, wherein the unitary molded body is molded from optical silicone and is sized to fit within an aperture of the substrate such that an edge of the aperture contacts the integral attachment portion to form a seal, the substrate located internal to the exterior component.

The unitary prescription optics disclosed herein provide a single lens optic with an integrally molded reflector, the optic capable of complex prescriptions that meet the regulatory requirements for regulated lighting applications. The unitary prescription optics can be made of conventional plastics and glass used to make lenses or can be made from optical silicone. The unitary molded optics disclosed herein are lighter weight even when made of plastic as no secondary lenses or reflectors are required. The unitary silicone prescription optics provide a much lighter lamp beneficial to all vehicles, and particularly autonomous vehicles and electric vehicles. Because the optic is a single component, the optics can reach 85% efficiency, a significant increase over conventional lamps, which lose between about 10%-15% efficiency for each component through which light passes. The optic can obtain greater than 55% efficiency, greater than 75% efficiency, up to 85% efficiency and more depending on the prescription. The unitary silicone prescription optics can be used with LEDs as the silicone has a higher temperature resistance than conventional plastic lenses. When made with silicone, the disclosed prescription optics are used without any coatings or outer lenses, as the silicone is impervious to UV damage and damage from road debris impingement. When made with silicone, the prescription optics disclosed herein can be mounted directly into the vehicle, without the need for additional sealant or gaskets, as the silicone acts as a seal, protecting the optic from weather related issues such as fogging, condensation and frost. Because the optic is one piece, there is no alignment necessary between components of the lamp when installed in the application.

These and other embodiments and aspects are contemplated herein.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a front perspective view of a unitary silicone prescription optic as disclosed herein.

FIG. 1B is a rear perspective view of the unitary silicone prescription optic in FIG. 1A.

FIG. 1C is a top plan view of the unitary silicone prescription optic in FIG. 1A.

FIG. 1D is a right-side view of the unitary silicone prescription optic in FIG. 1A.

FIG. 1E is a rear perspective view of a cross-sectional view of the unitary silicone prescription optic in FIG. 1A along line E.

FIG. 1F is a rear perspective view of a cross-sectional view of the unitary silicone prescription optic in FIG. 1A along line F.

FIG. 1G is a top plan view of the unitary silicone prescription optic in FIG. 1E.

FIG. 1H is a right-side view of the unitary silicone prescription optic in FIG. 1F.

FIG. 2 is a front perspective view of another aspect of a unitary silicone prescription optic as disclosed herein.

FIG. 3 is a front perspective view of yet another aspect of a unitary silicone prescription optic as disclosed herein.

FIG. 4A is a perspective view of a lamp with a single-stage optic as disclosed herein.

FIG. 4B is an exploded view of the lamp of FIG. 4A.

FIG. 5 is a top, front perspective view of another implementation of a lamp with a unitary silicone molded body as disclosed herein;

FIG. 6 is a right, top perspective view of the lamp of FIG. 5 illustrating an alternative attachment member;

FIG. 7 is an exploded view of FIG. 6;

FIG. 8A is a right side view of a unitary silicone molded body as disclosed herein and FIG. 8B is a cross-sectional view of FIG. 8A illustrating an opaque structure;

FIG. 9 is a rear view of the unitary silicone molded body with the opaque structure inserted therein;

FIG. 10 is another example of an opaque structure having a contoured member;

FIG. 11 is a front view of the lamp of FIG. 5 mounted directly to a vehicle exterior component;

FIG. 12 is a rear view of the lamp of FIG. 11 and the vehicle exterior component;

FIG. 13 is a vehicle on which the lamp of FIG. 5 is mounted;

FIG. 14A is a perspective view of a conventional symmetrical TIR;

FIG. 14B is an iso-candela plot of the symmetrical illumination pattern of FIG. 14A;

FIG. 15 is an iso-candela plot of a non-symmetrical illumination pattern produced by a lamp as disclosed herein;

FIG. 16 is a cross-sectional view of an imaging optic as disclosed herein;

FIG. 17 is an iso-candela plot of the non-symmetrical illumination pattern with a hot spot produced with a lamp and imaging optic as disclosed herein;

FIG. 18 is a lamp incorporating both a TIR optic and an imaging lens as disclosed herein;

FIG. 19 is a lamp incorporating multiple TIR optics and multiple imaging lenses as disclosed herein; and

FIGS. 20A-20C illustrate the use of an imaging optic between two lamps as disclosed herein, the imaging optic producing a hot spot in the illumination pattern as required in high beam and low beam vehicle applications.

### DETAILED DESCRIPTION

Conventional automotive lamps incorporate a light source, which may include a circuit board, a primary optic system, which can comprise a reflector and a separate lens, for example, and a secondary optic, which includes an outer lens, the components held in a housing. Additional lenses may also be included in the primary optic, such as a collimating lens, in certain applications, such as fog lamps. Reflectors are typically made of various plastics, via plastic injection molding, metal castings or stamped metal construction. Outer lenses of the secondary optic were typically glass, but have evolved to plastics, such as PC, PMMA, PS, COP and COCP, as examples. Where glass is weather and UV resistant, plastics are generally not. Thus, plastic outer lenses typically require a UV coating to protect against deterioration from sunlight, as well as a hard coating to protect against damage from impinging road debris. To further protect the lamp from weather, gaskets and/or sealants are necessary to properly seal the lamp at least between the outer lens and the housing.

These conventional lamps require multiple optics to properly collect, then shape the light into the desired illumination pattern. As light passes through multiple components, efficiency is lost. On average, about 10%-15% efficiency is lost with each component. Current automotive lamp efficiency is up to around 40%.

Disclosed herein are embodiments of a single-stage optic used with a light source and a housing to provide a lamp that is lightweight, has fewer components, is water-tight and UV resistant, among other benefits. The optics disclosed herein have a unitary molded body comprising: a front surface configured as a light exit; an integral reflector configured to receive and reflect light from an LED light source; and integral attachment portions configured to mount within a housing. The optics can be prescription optics. As used herein “prescription” refers to an optic or a lens that is designed to meet certain specification with regard to light or radiation pattern and intensity.

The lamps disclosed herein will be understood by those skilled in the art to have utility in numerous, various applications, including those applications having regulated specifications and those that do not. Applications having regulated specifications, for which the disclosed optics are particularly suited, include, without limitation, electric and motor vehicles (including automobiles, trucks, aircraft, watercraft, recreational vehicles, mopeds, motorcycles, ATVs, off-road vehicles, and the like), aerospace, and other lighting. Vehicle applications include, but are not limited to, headlamps, turn signal lamps, low beam lamps, high beam lamps, signal lamps, side lighting lamps, auxiliary lamps, tail lamps and fog lamps. The term “exterior vehicle lamp” used herein generally refers to those listed as well as others known and used in the industry. The disclosed optics are also suited for use in non-regulated and/or non-motorized vehicles, such as bicycles and electric bicycles.

Although the optics disclosed herein can be made from plastic or glass, optical silicone provides many advantages over the rigid plastic typically used in lenses. Common headlamp plastic lenses require the application of external anti-UV coatings in order to preclude the degradation of the plastic, which otherwise rapidly turns opaque, greatly reducing the functional performance as well as adversely impacting the appearance of the product. Such products commonly have a limited performance lifespan, leading to often severe optical degradation with extended sunlight (UV) exposure, a clear negative for products frequently or continually exposed to sun. Optical silicone is impervious to UV radiation damage. Optical silicone testing has demonstrated resistance to UV damage in excess of 10 years in direct sun exposure. No anti-UV coating is needed with optical silicone.

Conventional plastic lenses, particularly those used on vehicle headlamps, require hard coatings in order to mitigate the rapid surface degradation brought about by foreign object impingement, occurring, for example, during travel. Optical silicone has an inherent resistance to gravel and other road debris impingement. The soft, rubber-like properties of optical silicone are such that, rather than imbedding and/or damaging the surface of the plastic lenses, the energy is absorbed within the optical silicone without adversely affecting the optical clarity of the material, with the debris simply bouncing-off without imparting physical damage to the optic silicone material.

Plastics used to make lenses shrink while cooling, which leads to the loss of critical optical shape definition as the material pulls away from the desired tool optical geometry. This can be particularly pronounced in large molds, with large optical lens volumes leading to undesirable deformations in other critical optic areas. The industry has sought to address such issues via multi-step molding solutions, whereby lenses are produced via successive molding “steps” thereby accumulating material in subsequent molding operations so as to control shrink and thereby deliver accurate as-molded optical performance. Such processes are inherently expensive, given the multi-shot nature of the molding equipment.

Optical silicone can be molded/formed accurately in a large format optic with no sink or other optical aberrations and in a single mold process. Optical silicone optics are formed with a thermoset process, which utilizes a catalyst along with heat input to cure the optic into its final configuration. Rather than shrink, silicone effectively expands during the molding process, thereby enabling a highly accurate replication of the optical surface, in a single molding step. Optical silicone is rubber-like in nature. The flexibility of optical silicone provides the ability to incorporate flexible elements, the ability to incorporate significant “undercuts”, which otherwise would prevent plastics to be removed from the mold without incorporating mold action, and the ability to significantly deform yet return to its as-molded shape.

Yet another advantage of using optical silicone is its significantly higher temperature resistance than other common optical-grade plastics, which make optical silicone particularly useful in LED applications where close proximity between the optical element and the LED source is functionally advantageous. Such close proximity between LEDs and conventional plastic lenses is often precluded due to the thermal degradation brought about by high temperatures on plastic optics, for instance. Conventional clear plastics are only temperature resistant up to around 100° C. For example, PC is temperature resistant to about 120° C. and PMMA is temperature resistant up to about 90° C. Silicones are usually rated to remain thermally stable to temperatures in the area of 200° C., which is nearly double that of traditional optical grade plastics. Silicone optics can thus be placed near or directly over high temperature LED sources, thereby significantly improving optical performance while precluding damage over time, a critical functional advantage.

The ability to combine the outer lens, some or all of any additional lenses, and the reflector into a unitary body, providing full optical management, also provides many advantages.

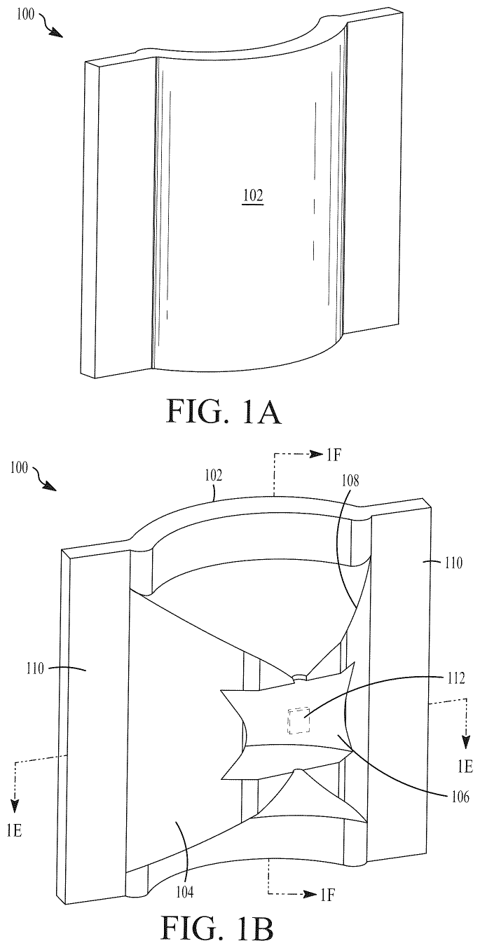

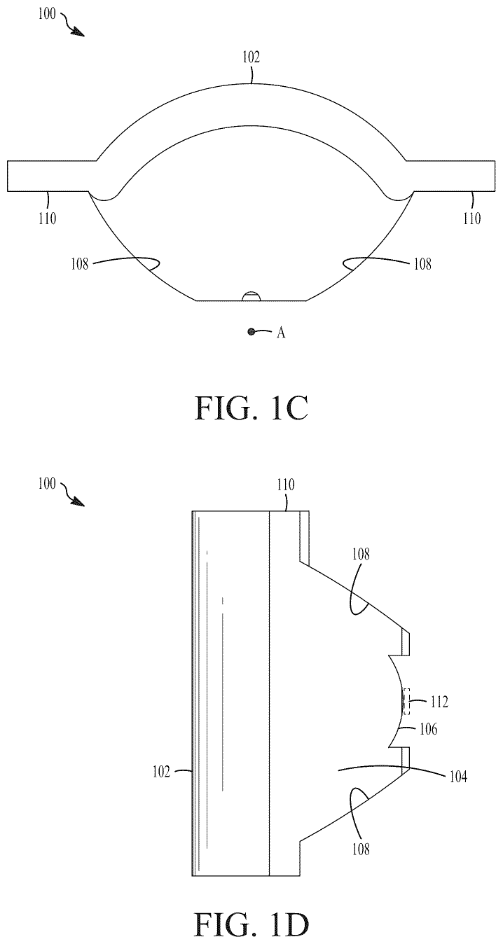

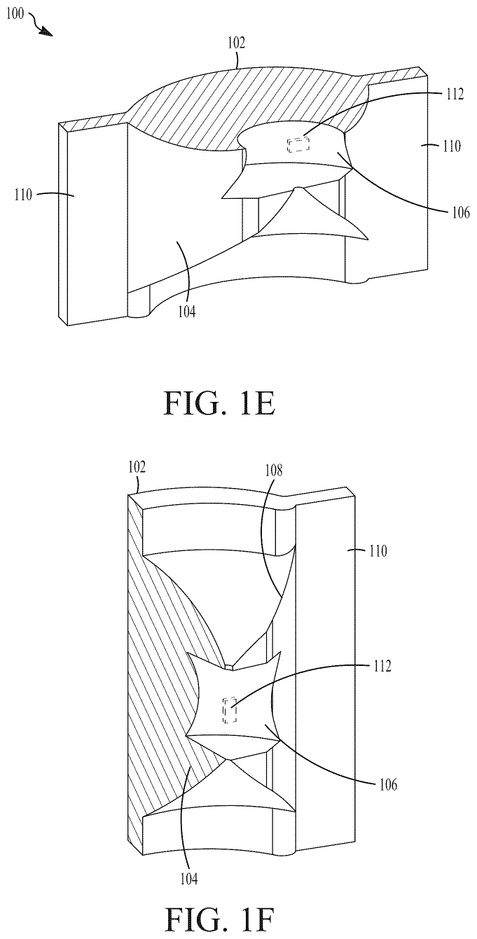

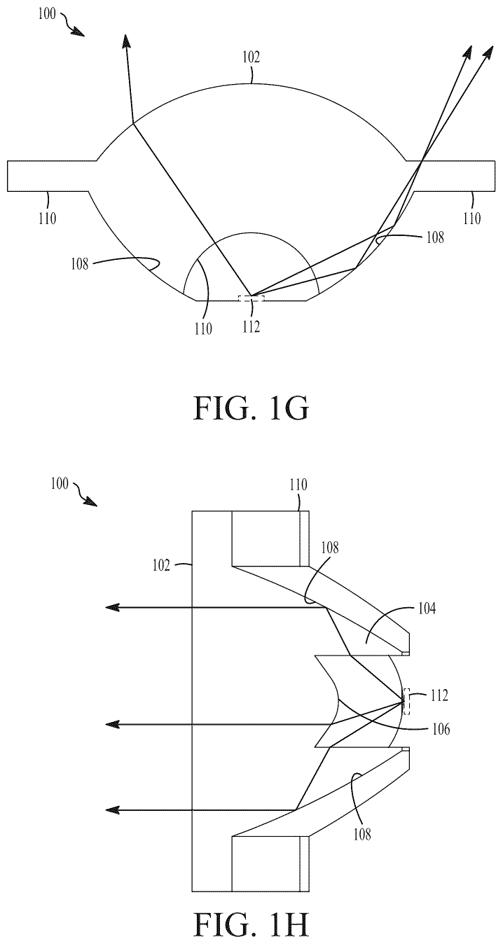

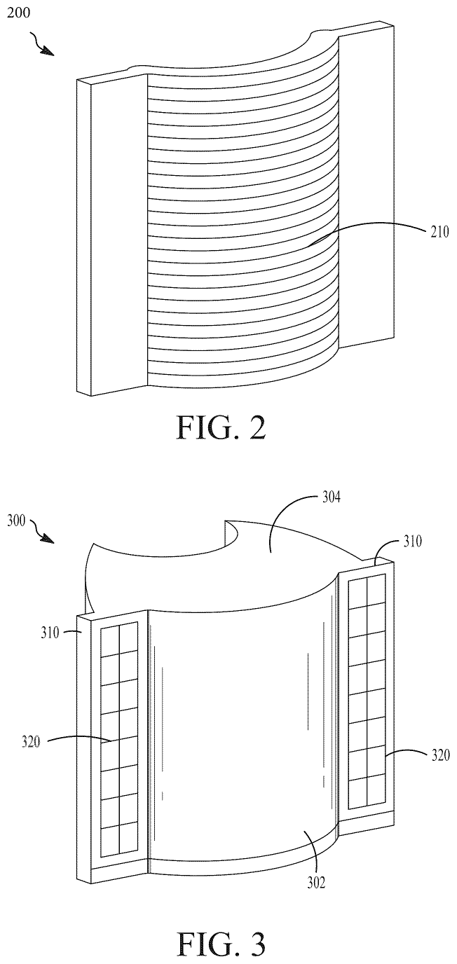

FIG. 1A is a front perspective view of an embodiment of a single-stage optic (one lens) for a lamp, or a unitary silicone monolith silicone prescription optic 100, and FIG. 1B is a rear perspective view of FIG. 1A. The front surface 102 is an exit surface through which light exits the optic. The front surface 102 can be smooth or can have vertical or horizontal flutes, such as the horizontal flutes 210 illustrated with the unitary silicone prescription optic of FIG. 2. The front surface 102 may have pillows, or other contours that are necessary to provide the requisite light pattern and/or intensity. The flutes or pillows are molded into the front surface 102 as the prescription optic 100 is molded. The front surface 102 is designed to meet the prescription and specifications for which it will be used. The front surface 102 is coating-free in use. No coating for UV protection or damage protection is required as the silicone material is UV resistant and impervious to damage from impinging debris.

As seen in FIG. 1B, the reflector 104 is integrally molded with the front surface 102. The reflector 104 is configured to receive and reflect light from an LED light source 112, shown in broken line. The reflector 104 will have one or more light receiving surfaces 106 which are reflective surfaces formed around a vertical axis. The reflector 104 also has multiple light reflecting surfaces 108. Four light reflecting surfaces are illustrated. FIG. 1D is a side view of the unitary silicone prescription optic 100. FIG. 1E is a perspective view of a cross-section of FIG. 1B along line E, and FIG. 1F is a perspective view of another cross-section of FIG. 1B along line F. FIG. 1G is a top plan view of FIG. 1E, and FIG. 1H is a right-side view of FIG. 1F when viewing from the front. Together FIGS. 1G and 1H illustrate the four light reflecting surfaces 108 illustrated in this embodiment. The four light reflecting surfaces 108, providing four total internal reflection (TIR) faces, gather the light, making up to 85% efficiency possible while providing sharpness and pattern control. The reflector 104 is shaped depending on the prescription, application and specifications. The reflector illustrated herein is provided as an example and is not meant to be limiting.

The unitary silicone prescription optic 100 also has integral attachment portions 110 that will hold the unitary silicone prescription optic 100 in a housing. Due to the rubber-like, flexible nature of the optical silicone, the unitary silicone prescription optic 100 is its own sealing gasket to sealing contact the housing. Conventional rigid plastic requires the use of a gasket and/or sealant between the lens and the housing to seal the interior against moisture, for example, from rain, snow and humidity, which can ice over the internal of the lamp, fog the interior of the lens or otherwise form condensation on the interior of the lens. Such a gasket or other additional sealing member is not needed as the contact between the housing and the unitary silicone prescription optic 100 is such that it seals against weather without the need for a gasket or other additional sealing member.

The rubber-like flexibility of optical silicone renders thin lenses, or thin areas of lenses, prone to deformation due to external forces such as gravity, external mechanical pressure, aerodynamic pressure, vibrations, etc. Although the integral combination of the lens and the reflector in the disclosed unitary prescription optics will generally result in a structure that is sufficiently thick, and therefore not impacted by the rubber-like flexibility with regard to deformation, some portions of the disclosed unitary prescription optics may be thin enough to be impacted. Accordingly, internal reinforcement in the thin portions may be desirable.

FIG. 3 illustrates another aspect of a unitary silicone prescription optic 300. As illustrated, the unitary optic 300 is thicker where the lens, or front surface 302, and the reflector 304 are molded and are thinner at the attachment portions 310. To provide structural mechanical strength to the attachment portions 310, a reinforcing structure 320, such as a reinforcing grid, is molded within and fully captured in the silicone material of the attachment portions 310. The unitary prescription optic 300 is internally reinforced at the attachment portions 310 by the suitable mechanically strong reinforcing structure 320, as well as the thickness of the remainder of the optic. The reinforcing structure 320 can be of any design that provides sufficient structural support to the optic and may be selected based on aesthetics or other reasons. The reinforcing structure 320 may be constructed from a variety of known materials, such as, but not limited to, thin wires, molded plastics, cast or molded metals, metal stampings and the like.

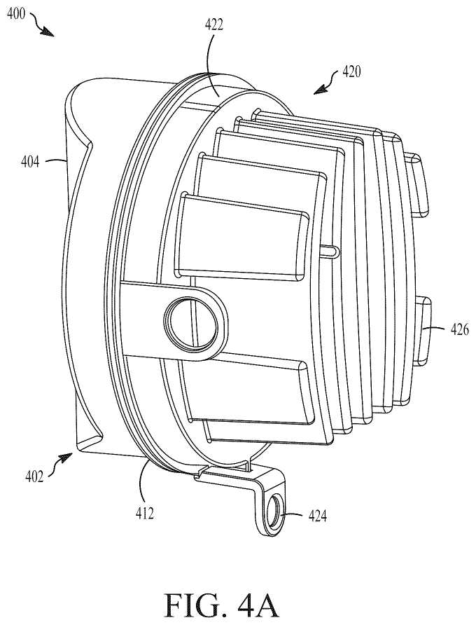

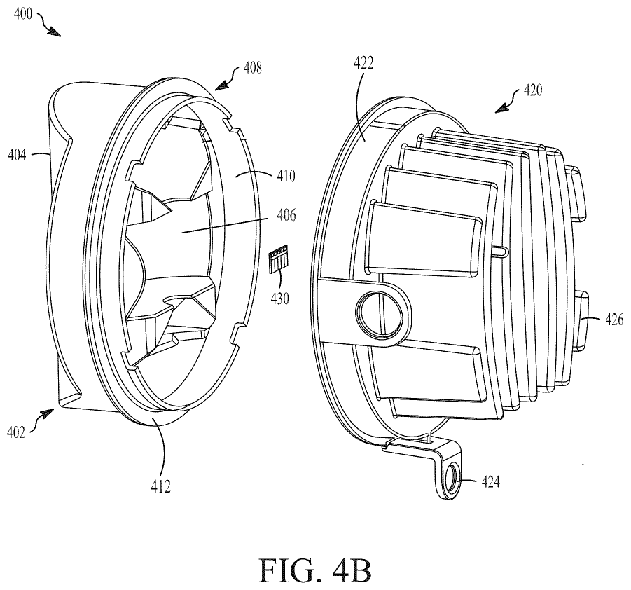

Also disclosed herein are lamps having a single-stage optic, such as for vehicles. One example of a lamp for a vehicle with a single-stage optic is illustrated in FIGS. 4A and 4B, with FIG. 4B being an exploded view of FIG. 4A. The lamp 400 has a unitary molded body 402 molded from silicone. The unitary molded body 402 has a round cross-section and is different from those depicted in the other drawings as a means of providing an example of a different shape and prescription. It is to be noted that the unitary molded body can have any cross- sectional shape as required by the design of the lamp such that it engages the housing. The unitary front surface and reflector can be of differing designs depending on the prescription. In FIG. 4, the unitary molded body has a front surface 404 configured as a light exit, an integral reflector 406 molded to meet a prescription light output, and an integral attachment portion 408. As shown, the attachment portion 408 has a first attachment member 410 and a second attachment member 412. The attachment portion 408 can be of any configuration that provides the requisite attachment to the housing, creating a water-tight seal without the need for an additional sealing member such as a gasket. The attachment portion 408 in FIG. 4 includes the first attachment member 410 to fit within a housing 420 and the second attachment member 412, contacting the housing in a flange-like capacity. Either or both of the first attachment member 410 or the second attachment member 412 can include a reinforcing structure as previously described.

The lamp 400 also includes an LED light source 430, the integral reflector receiving and reflecting light from the LED light source 430. The LED light source is not limited and can be one or more LEDs and can include a circuit board and/or other means of powering and controlling the LED(s). A housing 420 is configured to sealingly engage the unitary molded body 402 as well as mount the unitary molded body 402 within a vehicle exterior, the integral attachment portion 408 attached directly to the housing 420 without an additional seal member. The housing 420 includes a single stage lens attachment 422 configured to attached to the unitary molded body 402, attachment members 424 to attach the lamp 400 to a vehicle or other lighting application, and, optionally, a heat sink 426. The heat sink 426 may also or alternatively be provided at the LED light source.

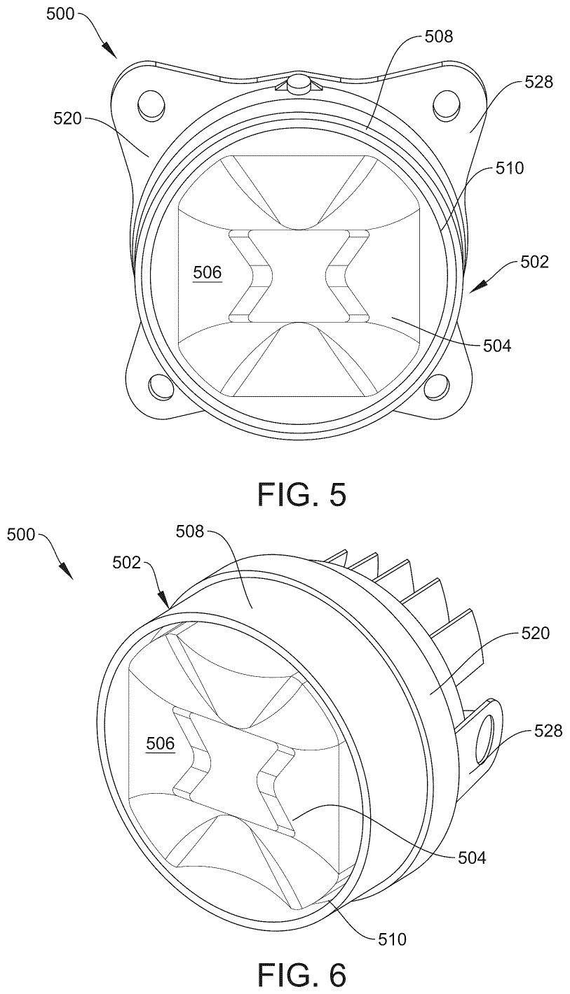

FIGS. 5-10 illustrate another embodiment of a lamp that is similar to lamp 400. Lamp 500 has a unitary molded body 502, the unitary molded body 502 having a TIR 504 with a front surface 506 configured as a light exit and an attachment portion 508 extending from a perimeter 510 of the front surface 506. An opaque structure 512 is configured as a light barrier to prevent light from exiting through a surface other than the front surface 506. When the unitary molded body 502 is made from optical silicone, the opaque structure 512 is also configured as a reinforcement structure to support the flexible silicone attachment portion 508. A housing 520 carries a light source 522, the housing 520 in contact with one or both of the attachment portion 508 and the opaque structure 512 to enclose the lamp 500.

The TIR 504, as illustrated in each of FIGS. 1B, 4B and 5-9, is non-symmetrical in shape. This non-symmetrical shape allows for a non-symmetrical illumination pattern without the need for any additional lenses or reflectors. Accordingly, the unitary molded bodies described herein can consist of a TIR optic with a front surface and an attachment portion, with the lamp having only the unitary molded body as a single light reflecting optic. The non-symmetrical illumination pattern will be described in more detail below.

As illustrated in FIGS. 1B, 4B and 5-9, the integral attachment portion 508 extends from at least a portion of the perimeter 510 of the front surface 506. The integral attachment portion 508 can extend from the perimeter 510 of the front surface 506 in a rearward direction R, substantially perpendicular to the front surface 506, as illustrated in FIGS. 5-9, forming a flexible skirt. FIGS. 4A and 4B show a similar configuration. Alternatively, as illustrated in FIG. 1A, the integral attachment portions 110 may extend from the perimeter in a radial direction.

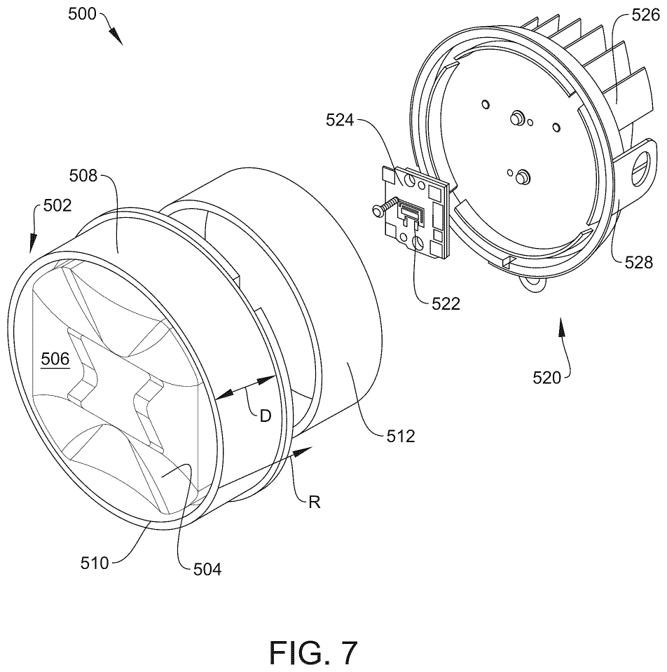

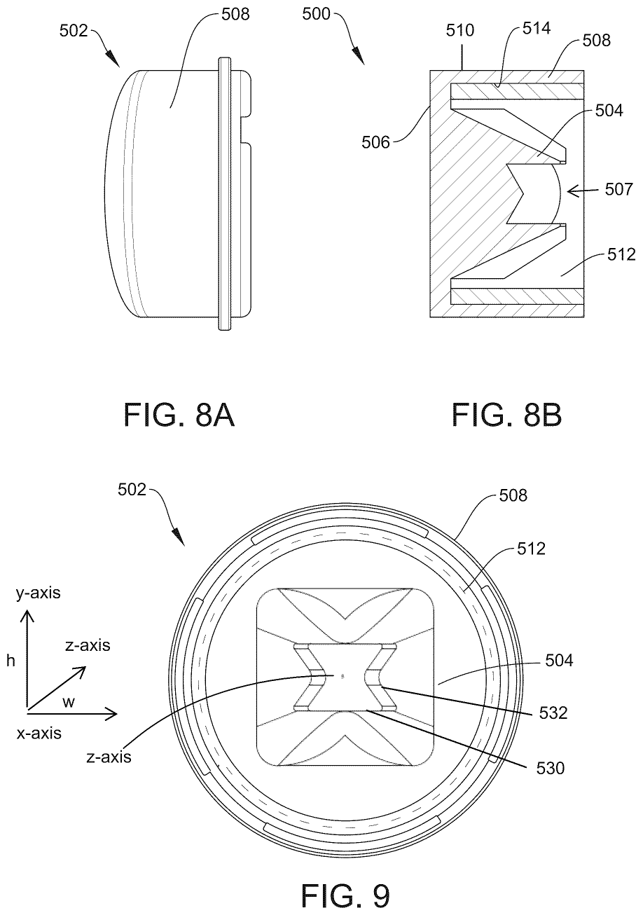

The opaque structure 512 is positioned adjacent to the integral attachment portion 508 and interior to the integral attachment portion 508 as illustrated in FIGS. 8B and 9, views of the unitary molded body with the opaque structure 512 inserted into the body. When the unitary molded body 502 is molded from silicone, the opaque structure 512 both provides structural support to silicone forming the flexible skirt and acts as an optical barrier. When the material of the unitary molded body 502 is plastic or glass, the opaque structure 512 acts as an optical barrier. As illustrated in FIG. 7, the integral attachment portion 508 extends in the rearward direction R to have a depth D, and the opaque structure 512 can extend from the front surface 506 to have a substantially equal depth such that one or both of the integral attachment portion and the opaque structure contacts the substrate to enclose the lamp to prevent light from exiting the side surfaces of the TIR, as illustrated in FIG. 8B. The integral attachment portion 508 may extend from the entire perimeter 510 of the front surface 506 and the opaque structure 512 may extend around the entire perimeter 510 of the front surface 506 on an internal side 514 of and, in some cases, in contact with the integral attachment portion 508. The opaque structure 512 may extend around less than the entire perimeter 510. However, as it is an optical barrier, it will typically extend a majority of or all of the extent of the attachment portion 508.

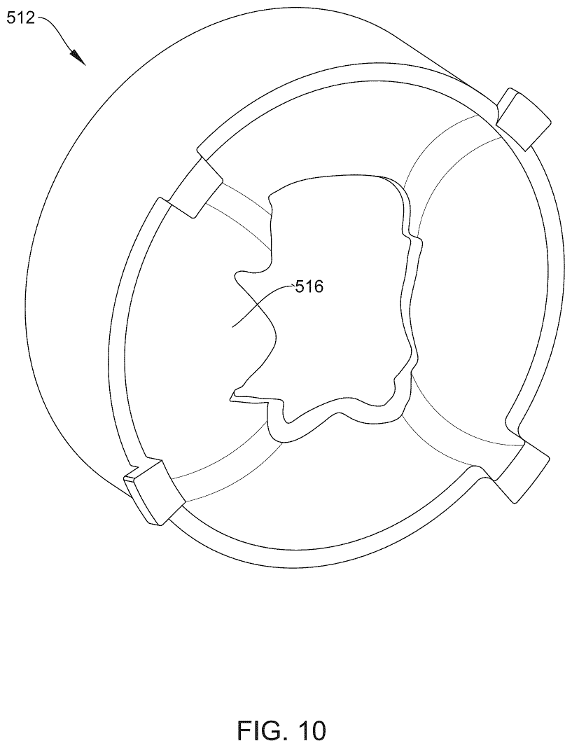

The opaque structure 512 is shown as a ring in FIGS. 7 and 9. However, the opaque structure can have any shape that coincides with the shape of the perimeter of the front surface or the shape of the internal attachment portion. For example, the front surface may be an overall square or rectangle, with the attachment portion extending from this perimeter in the same shape. The opaque structure may also be in the same shape if a square or rectangle. The opaque structure 512 may optionally also have a contoured portion 516 configured to align with contours of the TIR 504 internal to the lamp 500, as illustrated in FIG. 10. The contoured portion 516 decreases stray light reflections, including those from a circuit board, the LEDs themselves or any other internal element with may reflect light in an uncontrolled manner.

The housing 520 is essentially a base or substrate configured to carry one or more of the light source 522, a circuit board 524, and a heat sink 526. The housing 520 may also have one or more attachment members 528.

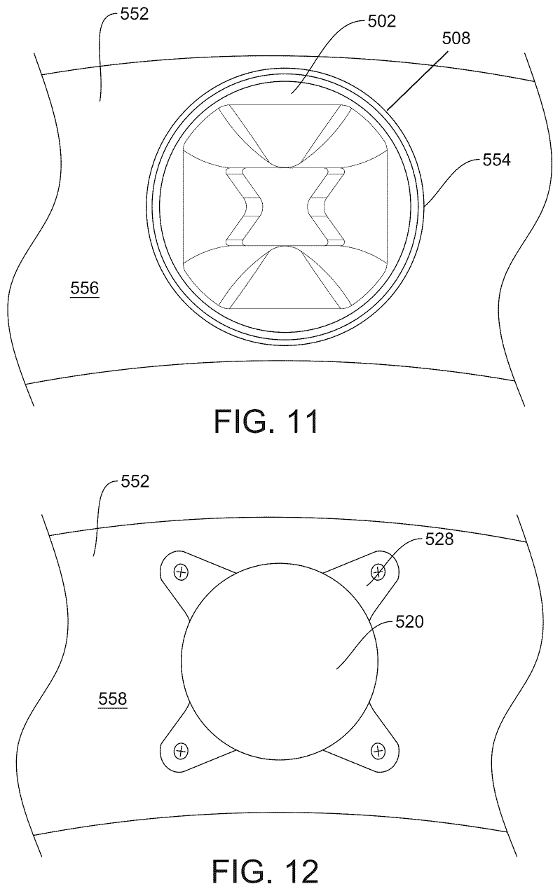

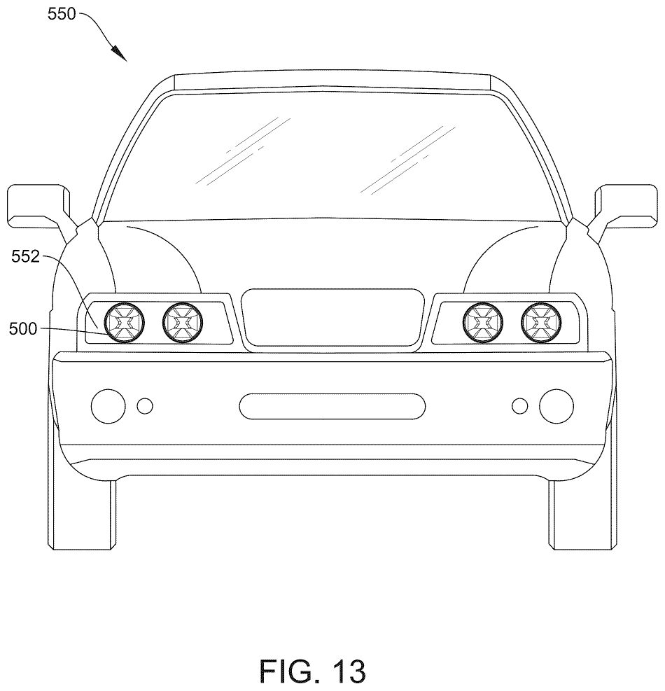

As illustrated in FIGS. 11-13, also disclosed is a vehicle 550 with an exterior component 552 having an aperture 554, an external surface 556 shown in FIG. 11, and an internal surface 558 shown in FIG. 12. The lamp 500 is mounted directly to the exterior component 552 of the vehicle 550. When made of optical silicone, the unitary molded body 502 is sized to fit within the aperture 554 such that an edge of the aperture 554 contacts the attachment portion 508. The housing 520 is located internal to the exterior component 552. For example, the unitary molded body 502 is pushed through the aperture 554 from an internal vehicle side of the exterior component 552 and when in place, the housing 520 is attached to the vehicle using the attachment members 528. The attachment members 528 may be of any number and structure sufficient to attach the lamp to the vehicle, whether it is to the inside of the vehicle component or to another part within the vehicle. From outside the vehicle 550, only the unitary molded body 502 is seen. The attachment portion 508, due to its flexible nature from the silicone, forms a gapless seal with the exterior component 552 within the aperture 554. The lamp 500 can be adjusted or aligned as required while in the aperture due to this flexible, compliant silicone “skirt” or attachment portion 508. The attachment portion 508 has enough give against the exterior component 552 to allow for the necessary alignment, which typically requires a movement of up to about 4 degrees either vertically and/or horizontally. The exterior component 552 may be a grill, exterior body panel, or fender, as non-limiting examples.

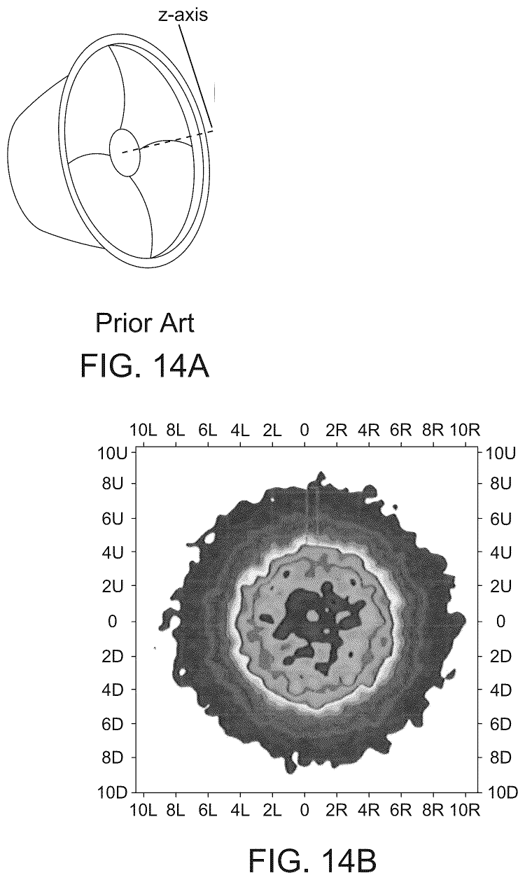

Conventional TIR optics are symmetrical in shape and produce a symmetrical illumination pattern. Additional optics (lenses, reflectors, secondary optics, surface modification, etc.) are required to change the shape or spread of the illumination pattern. Due to the symmetrical shape of conventional TIR optics, only one LED chip, or potentially multiple LED chips arranged symmetrically around the center axis A of the optic is generally used. FIG. 14A illustrates a conventional frustoconical TIR optic having a center z-axis of the optic. FIG. 14B is an iso-candela plot showing the symmetrical illumination pattern around the z-axis. Conventionally, for example, symmetrical TIR optics with secondary optics have been employed to produce the necessary illumination pattern for high beams, while low beams and fog lamps continue to be conventional ellipsoid, Fresnel or other conventional reflector optics rather than TIR optics.

The TIR optics disclosed herein are non-symmetrical about the z-axis of the optics at a light-receiving end 507 (shown in FIG. 8B) of the TIR optic and produce a non-symmetrical illumination pattern. This can be seen in FIGS. 1B, 4B and 9 (showing the y-axis, the x-axis and the z-axis). The z-axis is perpendicular to the front surface. The TIR optics disclosed herein are generally rectangular in cross section and have been developed to enable full or partial optical shaping of LED light outputs for regulated, prescription lamps for vehicles in a single optical step with no secondary optics needed. The TIR optics disclosed herein allow for a smooth front surface, allowing for the unitary molding of the TIR optic with the outer surface and attachment portion as a single element. The front surface 506 can be any shape desired for the appearance of the lamp, such as circular, square or rectangular as illustrated in the figures.

As shown in FIG. 9, the lamp 500 for a vehicle has a unitary molded body 502 having the TIR 504 with the light-receiving end 507 and a front surface 506 opposite the light-receiving end 507, and the integral attachment portion 508. The light-receiving end 507 of the TIR 504 has a width w along an x-axis, a height h along a y-axis, and a z-axis perpendicular to the front surface 506. The light-receiving end 507 is contoured to have a first shape 530 along the x-axis and a second shape 532 along the y-axis, the first shape 530 being different than the second shape 532.

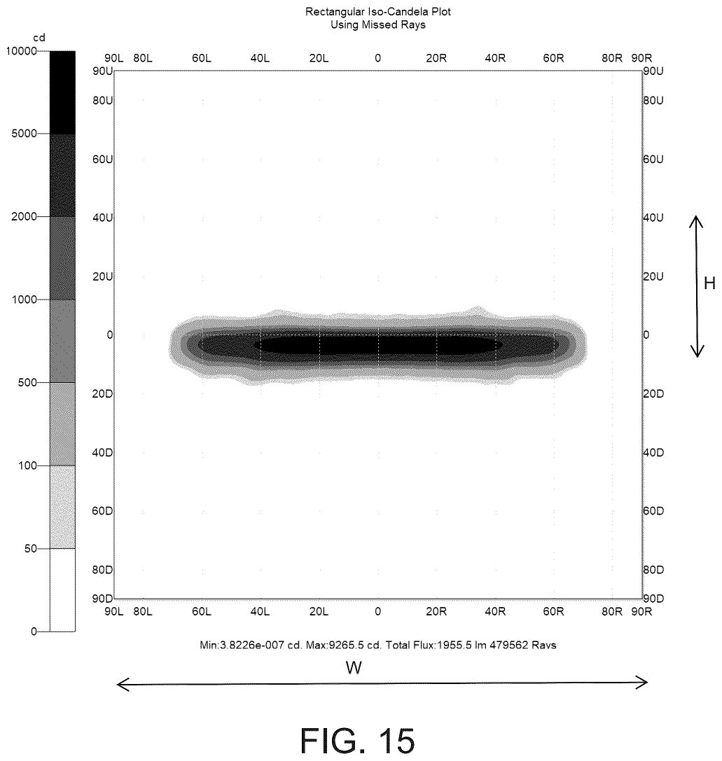

FIG. 15 is an iso-candela plot of the non-symmetrical illumination patterns produced by the disclosed non-symmetrical TIR optics. The TIR 504 is configured to produce an illumination pattern shown in FIG. 15 having a height H on a y-axis and a width W on an x-axis, wherein the illumination pattern is non-symmetrical about a z-axis and is produced using no secondary reflectors, secondary lenses or other secondary optics. As noted, the non-symmetry is determined from the z-axis, and in FIG. 15 the width of the illumination pattern is greater than the height of the illumination pattern. The width W of the illumination pattern has a spread of greater than 100° and the height H of the illumination pattern has a spread of less than 100°. The width W of the illumination pattern may have a spread of equal to or greater than 120°. The width W of the illumination pattern may have a spread of equal to or greater than 130°. As shown, the non-symmetrical TIR optics can produce a non-symmetrical illumination pattern with up to about 160° spread. The vertical spread, shown as height H, is smaller, with less than 100° of spread. When the disclosed unitary optics are used as exterior vehicle lamps, the visibility laterally is vastly expanded and improved. When the non-symmetric illumination pattern is seen in use in a vehicle at night, the improvement is significant. Such improvements in visibility would be equally important on a motorcycle or off-road vehicle, including non-motorized bicycles. The non-symmetrical illumination pattern can be turned vertically to make an improved flood light. Because of the non-symmetrical shape of the TIR optic, more than one LED chip can be used for one optic, arranged in one or more arrays or other non-symmetrical patterns.

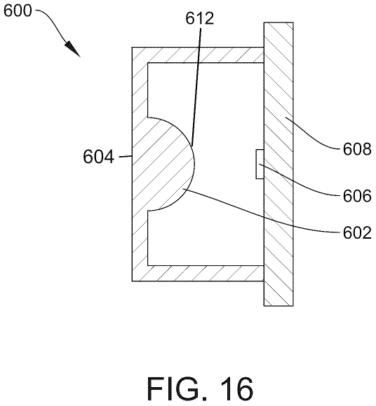

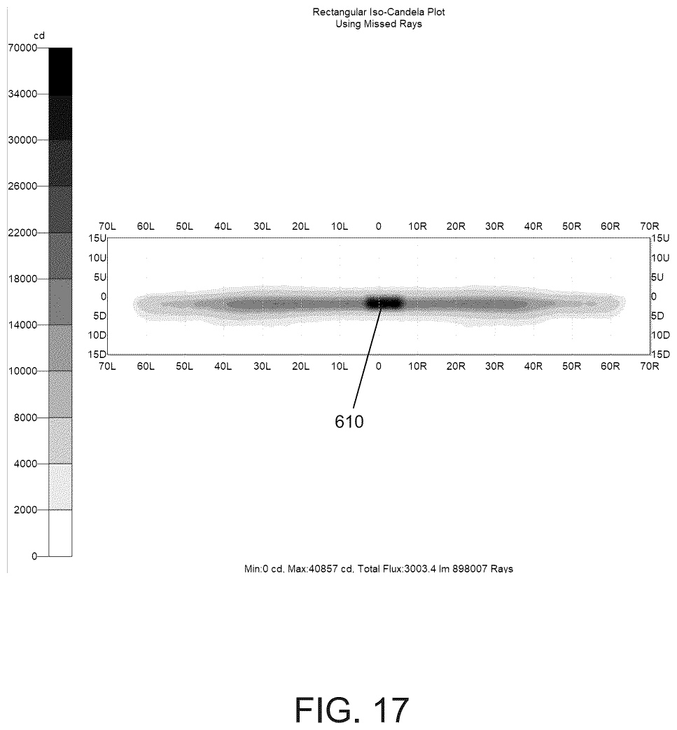

Regulatory requirements require a hot spot for vehicle high beams and low beams, a high intensity spot of illumination to assist in seeing distance, aiding in safety and driver comfort. To create this hot spot to meet regulatory requirements, while not reducing the spread achieved with the unitary molded body forming a TIR optic as disclosed herein, an imaging optic 600 can be used. As illustrated in FIG. 16, one implementation of an imaging optic 600 is illustrated in cross-section. The imaging optic 600 has an imaging lens 602 that is convex when viewed from a light-receiving surface 612 opposite a front surface 604 of the imaging optic 600, such that the light from an LED enters the optic through the convex surface of the imaging lens 602. The imaging optic 600 includes an imaging lens light source 606, such as an LED, that can be carried by a substrate 608. The imaging optic 600 acts like a magnifying glass, placed in a geometrical location, which enables the projection of the LED shape down the road. This concentrated image of the LED's output creates a high intensity zone, or a hot spot 610, as seen in FIG. 17. The imaging lens 602 or imaging optic 600 is aligned to produce an illumination hot spot 610 in the illumination pattern produced by the TIR proximate the z-axis. The geometrical location is such that the hot spot overlays is or proximate a center of the TIR optic's non-symmetrical illumination pattern. FIG. 17 is an iso-candela plot of a low beam application using a TIR optic and imaging optic as disclosed herein. The hot spot 610 can reach over 30000 cd.

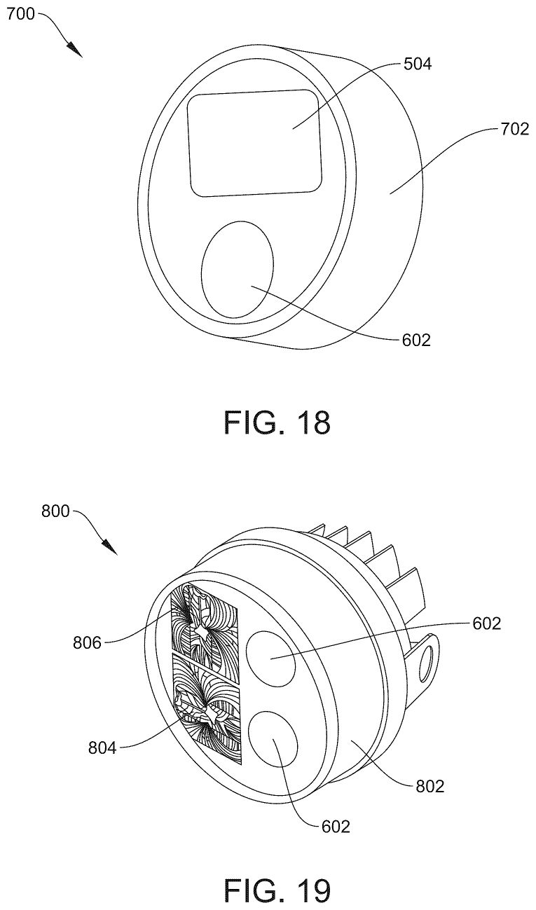

As disclosed herein a high beam or low beam headlight 700 has a unitary molded body 702 with a TIR 504 as disclosed with respect to FIGS. 1B, 4B and 9. The high beam or low beam headlight 700 also has a TIR light source (522 in FIG. 7), an imaging lens 602 having a light-receiving surface 612 that is convex and a front surface 604 opposite the convex light-receiving surface, and an imaging lens light source 606. The imaging lens 602 is aligned to produce an illumination hot spot in an illumination pattern produced by the TIR 504. The imaging lens 602 may be integral with the unitary molded body 702, the imaging lens 602 positioned adjacent to the TIR 504, as illustrated in FIG. 18. Alternatively, the imaging lens 602 may be positioned within an imaging optic 600 (FIG. 16) that is separate from the unitary molded body 502 with the TIR, the imaging optic 600 positioned adjacent to the unitary molded body.

The imaging optic 600 can be a stand-alone member as illustrated in FIG. 16, mounted separately from the lamps 500. Alternatively, as illustrated in FIG. 18, the imaging lens 602 can be incorporated into a unitary molded body 702 that includes the TIR 504 in the high beam or low beam function. A lamp 800 can include a unitary molded body 802 with both a high beam TIR optic 804 and a low beam TIR optic 806, each with a respective imaging lens 602, as illustrated in FIG. 19, providing the hot spot needed to produce the prescribed illumination pattern of a high beam and low beam. These are provided as examples and are not meant to be limiting.

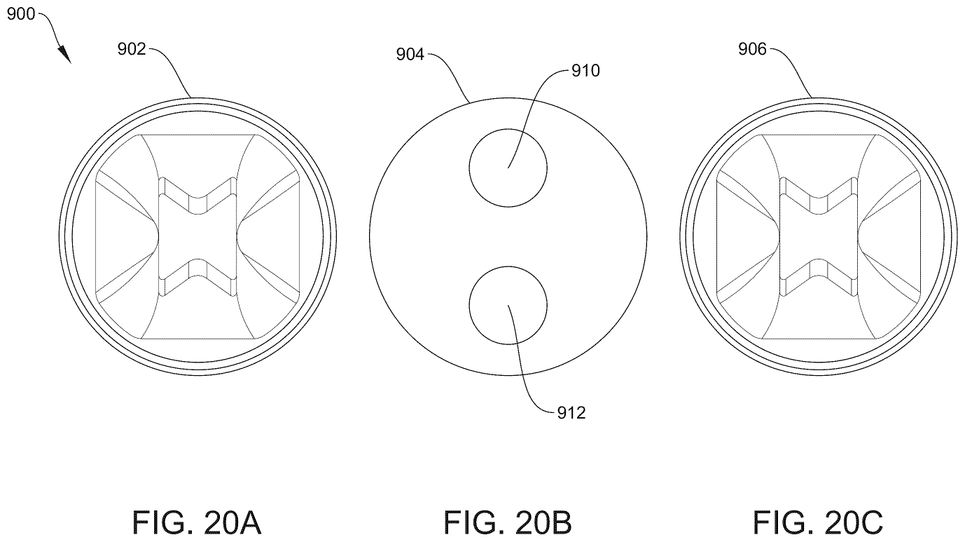

As illustrated in FIGS. 20A-20C, there is a lamp system 900 that includes a unitary molded body with a TIR 902 as disclosed herein, an imaging optic 904, and another unitary molded body with a TIR 906 as disclosed herein. The imaging optic 904 has a first imaging lens 910 and a second imaging lens 912 that are positioned to create a hot spot for TIRs 902, 906 respectively, each imaging lens 910, 912 having an LED light source. With the hot spot produced by the imaging lens 910, 912, unitary bodies with TIRs 902, 906 become a high beam and low beam. The imaging optic 904 is positioned adjacent to both TIRs 902, 906, so in FIGS. 20A-20C is between them.

The lamps disclosed herein can be made in any shape or diameter desired for aesthetic reasons by changing the shape of the front surface. The TIR will not change from its overall rectangular shape as that shape produces the non-symmetrical illumination pattern. However, the size of the TIR can be adjusted. Examples of the overall lamp diameter include, but are not limited to, 60 mm diameter, 90 mm diameter, 4.5 inches diameter and 7 inches diameter. The lamps disclosed herein can reduce power consumption, fulfilling approximately two times or more the illumination output with about half the power consumption. As a non-limiting example, a fog lamp made with the unitary molded silicone optics as disclosed herein may consume 14 watts and produce a beam spread of 150° while an OEM fog lamp fitted with a halogen bulb consumes 55 watts while only producing a beam spread of 90°.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A lamp for a vehicle, comprising:
a unitary molded body, comprising:
a total internal reflection (TIR) optic having a front surface configured as a light exit; and
an integral attachment portion extending from at least a portion of a perimeter of the front surface; and
an opaque structure adjacent to and on an internal side of the integral attachment portion.

2. The lamp of claim 1, wherein the integral attachment portion extends from the perimeter of the front surface in a rearward direction substantially perpendicular to the front surface.

3. The lamp of claim 2, wherein the integral attachment portion extends in the rearward direction to have a depth, and the opaque structure extends from the front surface to have a substantially equal depth.

4. The lamp of claim 1, wherein the integral attachment portion extends from an entire perimeter of the front surface and the opaque structure is positioned internal to and in contact with the integral attachment portion.

5. The lamp of claim 4, further comprising:
a substrate configured to carry one or more of a light source, a circuit board, and a heat sink, wherein one or both of the integral attachment portion and the opaque structure contacts the substrate to enclose the lamp.

6. The lamp of claim 1, wherein the integral attachment portion extends from the perimeter of the front surface in a radial direction.

7. The lamp of claim 1, wherein a shape of the TIR optic is non-symmetrical about a center axis of the TIR optic, the center axis being perpendicular to the front surface.

8. A vehicle, comprising:
an exterior component having an aperture; and
the lamp of claim 5, wherein the unitary molded body is molded from optical silicone and sized to fit within the aperture such that an edge of the aperture contacts the integral attachment portion to form a seal, the substrate located internal to the exterior component.

9. The vehicle of claim 8, wherein the exterior component is a grill, body panel, or fender.

10. A lamp, comprising:
a unitary molded body forming a TIR optic with a front surface configured as a light exit and an integral attachment portion extending from a perimeter of the front surface;
an opaque structure configured as a light barrier to prevent light from exiting through a surface other than the front surface; and
a substrate carrying a light source, the substrate in contact with one or both of the integral attachment portion and the opaque structure to enclose the lamp.

11. The lamp of claim 10, wherein the integral attachment portion extends from the perimeter of the front surface in a rearward direction substantially perpendicular to the front surface.

12. The lamp of claim 10, wherein the unitary molded body is molded from plastic.

13. The lamp of claim 10, wherein the integral attachment portion extends from an entire perimeter of the front surface and the opaque structure extends internal to and in contact with the integral attachment portion.

14. The lamp of claim 10, wherein the opaque structure has a contoured portion configured to align with contours of the TIR optic.

15. The lamp of claim 10, wherein a shape of the TIR optic is non-symmetrical about a center axis of the TIR optic, the center axis being perpendicular to the front surface.

16. The lamp of claim 10, wherein the unitary molded body is molded from optical silicone.

17. A lamp for a vehicle, comprising:
a unitary molded body, comprising:
an optic having a front surface configured as a light exit; and
an integral attachment portion extending from a perimeter of the front surface; and
an opaque structure internal to the integral attachment portion,
wherein the integral attachment portion extends from the perimeter of the front surface in a rearward direction substantially perpendicular to the front surface.

18. The lamp of claim 17, wherein the opaque structure extends in the rearward direction from the perimeter of the front surface adjacent the integral attachment portion.

19. The lamp of claim 17, wherein the opaque structure includes a contoured portion configured to align with contours of the optic.
